(19) United States
(12) Patent Application Publication
(10) Pub. No.: US 2006/0043195 A1
(43) Pub. Date: Mar. 2, 2006

(54) Rhythmic lighting method for a LED on a portable electronic device

(75) Inventors: Chieh-Yu Chan, Taipei City (TW); Shih-Chieh Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/142,460

(22) Filed: Jun. 2, 2005

(30) Foreign Application Priority Data
Aug. 27, 2004 (TW) 093125765

(51) Int. Cl. G06K 7/10

(52) U.S. Cl. 235/462.45; 235/472.01

(57) ABSTRACT

A rhythmic lighting method for a LED on a portable electronic device, and the portable electronic device can blink the LEDs with music tempo. Therefore, the user can not only listen to the music but also enjoy the rhythmic lighting vision effect. In addition, this present invention can change the illumination color of the LED to the user's satisfaction, or for different power states.

### BACKGROUND OF THE INVENTION

1. Field of the Invention

The present invention relates to a rhythmic lighting method and, more particularly, to a rhythmic lighting method for a LED on a portable electronic device.

2. Description of the Related Art

Currently, with improvements in electronics, electronic devices, such as PDAs and MP3 players, are getting smaller and smaller. These portable electronic devices are easy to carry, and provide special personal services or have powerful computing capabilities. As a consequence, these portable electronic devices provide convenience and entertainment, anywhere and at anytime.

A prior art lighting method for a LED on a portable electronic device employs both fixed lighting and color, set when the portable electronic device is manufactured, and users cannot change the lighting method.

Therefore, it is desirable to provide a rhythmic lighting method for a LED on a portable electronic device to mitigate and/or obviate the aforementioned problems.

### SUMMARY OF THE INVENTION

The present invention provides a rhythmic lighting method for a LED on a portable electronic device comprises: (A) determining whether the portable electronic device is playing audio; (B) if the portable electronic device is playing audio, performing a frequency quantification analysis to the audio; otherwise keeping the same status; (C) extracting a quantification value for a frequency section of the audio and determining whether the quantification value is exceeding a predetermined value; (D) if the quantification value exceeds the predetermined value, sending an enabling signal to the portable electronic device to execute a blinking action; and (E) if the quantification value is less than the predetermined value, the portable electronic device will keep the same status without performing lighting.

The blinking action is executed by the LED mounted on the portable electronic device, so the portable electronic device can blink the LED with music tempo. Therefore, the user can not only listen to the music but also enjoy the rhythmic lighting vision effect.

Other objects, advantages, and novel features of the invention will become more apparent from the following detailed description when taken in conjunction with the accompanying drawings.

### BRIEF DESCRIPTION OF THE DRAWINGS

FIG. 1a illustrates a multimedia player.

FIG. 1b is a functional block drawing of a multimedia player.

FIG. 2 is a flow chart of a method of the present invention.

### DETAILED DESCRIPTION OF THE PREFERRED EMBODIMENT

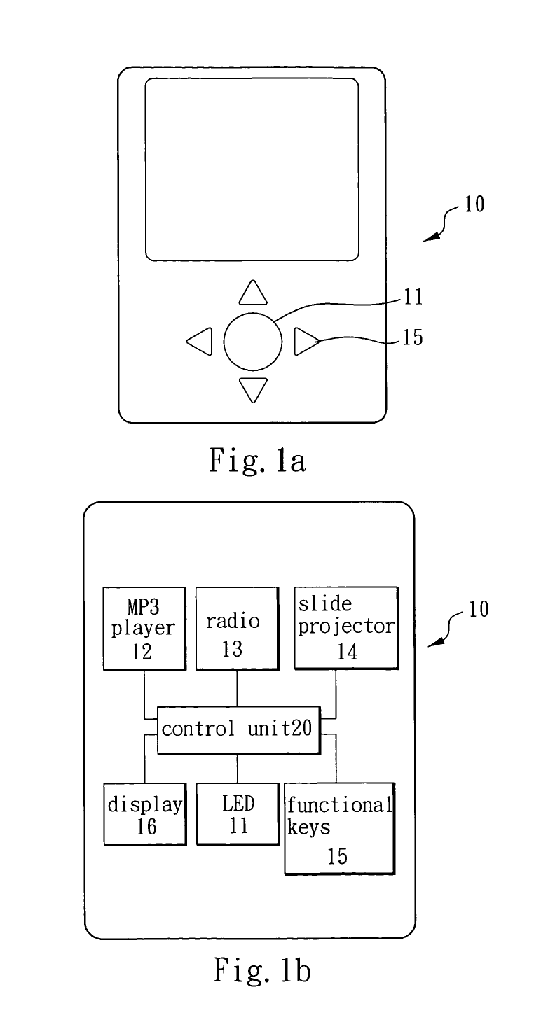

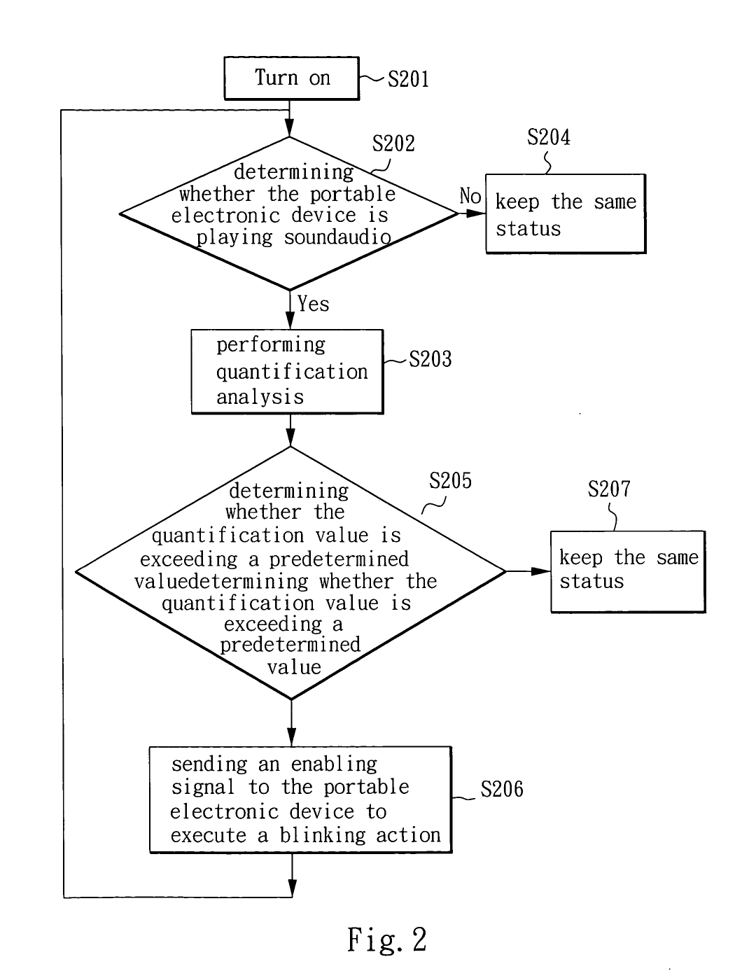

The present invention provides a rhythmic lighting method for a LED on a portable electronic device. In this embodiment, the portable electronic device is a multimedia player 10, and the multimedia player 10 comprises a MP3 player 12, a radio 13 and a slide projector capable of playing background music 14. FIG. 1a illustrates the multimedia player 10, and FIG. 1b is a functional block drawing of the multimedia player 10. In this embodiment, an LED 11 is used for illumination. The multimedia player 10 performs functions as selected by a plurality of function keys 15, and the LED 11 begins to blink according to the tempo of the audio playing on the multimedia player 10, such as a MP3 song, a broadcast show, or a slide projector, the information for which is displayed on a display 16.

Please refer to FIG. 3. FIG. 3 is a flow chart of a method of the present invention. When the multimedia player 10 is turned on (step S201), the multimedia player 10 detects whether a user has manipulated the function keys 15 to cause the multimedia player 10 to play music (step S202). When a control unit 20 of the multimedia player 10 receives a play music signal, the control unit 20 will send the selected music to a digital signal processor 18 for performing quantification analysis (step S203). If the control unit 20 does not receive a play music signal, the multimedia player 10 will keep the same status (step S204). The digital signal processor 18 uses Fourier Transformation to convert the received sound signal into a quantification value (in dB), and sends the digital value to the control unit 20. In this embodiment, the control unit 20 extracts the digital values for selected frequency at 707 Hz, 1.4 KHz, and 2.8 KHz; calculates an average value for these three values, and determining whether the quantification value is exceeding a predetermined value (step S205). In this embodiment, the predetermined value is 5 dB. If the average value exceeds 5 dB, the control unit 20 sends an enabling signal to the LED 11 so that the LED 11 blinks (step S206). If the average value does not exceed 5dB, then the LED 11 is kept the same status (step S207).

Additionally, the multimedia player 10 can change the illumination color of the LED 11 to the user's satisfaction, or for different power states.

Although the present invention has been explained in relation to its preferred embodiment, it is to be understood that many other possible modifications and variations can be made without departing from the spirit and scope of the invention as hereinafter claimed.

What is claimed is:

1. A rhythmic lighting method for an LED on a portable electronic device comprising:
(A) determining whether the portable electronic device is playing audio;
(B) if the portable electronic device is playing audio, performing a frequency quantification analysis to the audio; otherwise keeping the same status;
(C) extracting a quantification value for a frequency section of the audio and determining whether the quantification value is exceeding a predetermined value;
(D) if the quantification value exceeds the predetermined value, sending an enabling signal to the portable electronic device to execute a blinking action; and
(E) if the quantification value is less than the predetermined value, the portable electronic device will keep the same status without performing lighting.

2. The method as claimed in claim 1, wherein the portable electronic device is a multimedia player.

3. The method as claimed in claim 2, wherein the multimedia player is a radio.

4. The method as claimed in claim 2, wherein the multimedia player is a MP3 player.

5. The method as claimed in claim 2, wherein the multimedia player is a slide projector.

6. The method as claimed in claim 5, wherein the slide projector is a slide projector capable of playing background music.

7. The method as claimed in claim 1, wherein the lighting action is performed by a LED.

8. The method as claimed in claim 7, wherein the LED is mounted on an external case of the portable electronic device.

9. The method as claimed in claim 1, wherein in step (C), the predetermined value is 5dB.

10. The method as claimed in claim 1, wherein the audio is music with a tempo.

11. The method as claimed in claim 1, wherein the audio is a MP3 song.

12. The method as claimed in claim 1, wherein the audio is a wireless audio.
